(19) United States
(12) Patent Application Publication
(10) Pub. No.: US 2021/0131540 A1
(43) Pub. Date: May 6, 2021

(54) EXTERNAL HEAT ENGINE WITH NON-SINUSOIDAL MOTION

(71) Applicant: Ekstera Inc., Toronto (CA)

(72) Inventors: Brendan David MacDonald, Toronto (CA); Justin Roberto Rizzi, Mississauga (CA); Brayden Timothy York, Milford (CA)

(73) Assignee: Ekstera Inc.

(21) Appl. No.: 17/090,386

(22) Filed: Nov. 5, 2020

Related U.S. Application Data
(60) Provisional application No. 62/930,706, filed on Nov. 5, 2019.

(51) Int. Cl. F16H 37/12; F02G 1/02

(52) U.S. Cl. CPC F16H 37/124; F02G 1/02

(57) ABSTRACT

Various embodiments are described herein for methods and devices that relate to a drive mechanism that can be used in an external heat engine to control the motion of the pistons and obtain increased engine power and/or efficiency. Through control of the piston motion a non-sinusoidal piston motion can be generated which can improve engine performance by enabling an engine to more closely follow an ideal thermodynamic cycle.

### CROSS-REFERENCE TO RELATED APPLICATION

This application claims the benefit of U.S. Provisional Patent Application No. 62/930,706 filed Nov. 5, 2019; the entire contents of Patent Application 62/930,706 is hereby incorporated by reference.

### FIELD

Various embodiments are described herein that relate to a drive mechanism that can control the piston motion in external heat engines to more closely follow ideal thermodynamic cycles and obtain increased power generation and efficiency.

### BACKGROUND

Heat engines enable the conversion of thermal energy (heat) into useful shaft work output. There are internal and external heat engines, where internal refers to heat sources within the piston chambers and external refers to the use of heat sources that provide heat from outside of the piston chambers. External heat engines can therefore use a wide range of heat sources since they are not restricted by the combustion properties of fuels within the piston chambers. These sources can include traditional fossil fuels, which can be burned more cleanly and efficiently in external heat engines since their combustion can be strictly controlled outside of the pistons. However, other promising heat sources for external heat engines include sustainable options such as solar thermal energy, burning of biomass or biofuels, or waste heat from facilities. Since external heat engines can operate with a wide range of heat sources, they are also more reliable than traditional sustainable energy options, such as photovoltaic solar and wind turbines, which provide intermittent power based on the availability of the sun and wind. External heat engines can convert a wide range of sustainable heat sources into power, and therefore they are not dependent on a single intermittent source, and can provide a more reliable and sustainable solution for power generation.

Heat engines are able to convert heat into work output by operating on power cycles. Internal heat engines operate on cycles such as the Otto and Diesel cycles and external heat engines operate on cycles such as the Stirling and Ericsson cycles. The Stirling and Ericsson cycles are theoretically capable of achieving the peak efficiency for given operating conditions, known as Carnot efficiency, which means they have the potential to operate at a higher efficiency than other power cycles. The thermodynamic cycles represent an ideal framework for the operation of heat engines and there are deviations from these ideal cycles when actual engines are operated. Therefore, Stirling engines are attempting to follow the Stirling cycle, but there are many deviations from this ideal cycle due to physical limitations in conventionally designed Stirling engines, which result in a loss of work output and efficiency. To enhance the work output and efficiency of engines requires that the engines follow their ideal power cycles as closely as possible.

One deviation between ideal cycles and engines is due to the use of a crank shaft, which offers a simple and robust way to convert the linear motion of the pistons into rotational motion of the drive shaft. Due to their rotation, crank shafts are restricted in their motion and limited to providing sinusoidal motion for the pistons in heat engines. Another version of Stirling engines, known as the linear free piston arrangement, also operates on sinusoidal motion since the piston oscillates resonantly. However, sinusoidal piston motion prevents the engines from following their ideal power cycles and leads to substantial losses in work output and efficiency due to the thermodynamic consequences of the sinusoidal motion. This is especially true for external heat engines operating on the Stirling and Ericsson cycles since they require all of the working fluid to be in the cold volume during the compression portion of the cycle and in the hot volume during the expansion portion of the cycle. This requires that the pistons dwell, or remain stationary, during the expansion and compression portions of the cycle, which cannot be accomplished with sinusoidal motion, and leads to significant losses in power output and efficiency.

There is currently an increasing demand for reliable and sustainable sources of energy to address the expanding threat of climate change. There is also an increasing demand for convenient, affordable, and portable power generation to enable users to disconnect from their power grid, especially for remote communities. Power outages are becoming more common along with an increase in extreme weather, which increases the need for reliable power. Centrally located power generation stations suffer from localized pollution, distribution losses, power outages, and challenges in reaching remote communities. Diesel generators can provide portable power but they produce carbon dioxide emissions and other pollutants. Solar photovoltaic and wind turbines are sustainable options but they suffer from intermittency of the sun and wind, which renders them less reliable and increases dependence on costly energy storage systems. External heat engines could provide reliable, portable, and sustainable power, particularly for remote and emergency situations, but also for a distributed power network for urban settings too.

There is a high potential for external heat engines, such as Stirling and Ericsson engines, to solve critical issues by providing reliable and sustainable power. Some of the sustainable heat sources do not have as high of an energy density as traditional fossil fuels, so it is critical for Stirling and Ericsson engines to operate at high work output and efficiency levels, to be able to provide sufficient power. Thus, it is important to maximize the performance characteristics of external heat engines by adapting non-sinusoidal drive mechanisms to enable the engines to more closely follow their ideal power cycles.

### SUMMARY OF VARIOUS EMBODIMENTS

Various embodiments of methods and devices that relate to a drive mechanism to obtain increased engine work output and efficiency for external heat engines are provided according to the teachings herein. The embodiments described herein generally provide for non-sinusoidal linear piston motion with connection to a continuously rotating output shaft.

In a first aspect, in accordance with the teachings herein there is provided at least one embodiment described herein that provides an engine drive mechanism comprising: a first gear set including a first number of gears affixed to each other or attached to a common shaft to rotate together, the first gear set being coupled to a continuously rotating output shaft, each gear in the first gear set having a circumferential surface with at least one smooth portion and/or at least one toothed portion; a second gear set including a second number of gears, the second gear set being disposed about an axis of rotation, each gear in the second gear set having a circumferential surface with at least one smooth portion and/or at least one toothed portion and being arranged to abut against a corresponding gear from the first gear set to form a gear pair having a gear ratio; and a piston connected to the second gear set, the piston being configured to travel various distances during certain portions of each engine cycle when teeth on each gear in a given gear pair engage one another, and/or the piston is configured to dwell when smooth surface portions on each gear in the given gear pair are in slidable contact with one another.

In at least one embodiment, the piston has a force exerted on it by the second gear set and the piston exerts a force on the second gear set to transfer load and generate output shaft work.

In at least one embodiment, a number N of times that a toothed portion from a gear in one of the gear sets engages with the teeth from a gear in another of the gear sets during a single rotation of the second gear set is equal to a number of times the piston moves during a full cycle of the piston, where N is an integer.

In at least one embodiment, a ratio of pitch circle diameters for gears in a gear pair is selected to define a distance that the piston travels when toothed portions of the gears in the gear pair engage one another.

In at least one embodiment, a number M of times that a smooth surface from a gear in one of the gear sets slidably contacts a smooth concave surface from a gear in another of the gear sets during a single rotation of the second gear set is equal to a number of dwells during a full cycle of the piston, where M is an integer.

In at least one embodiment, a smooth surface portion of a first gear from the given gear pair has a shape for slideable contact with a smooth concave surface portion of a second gear from the given gear pair to prevent rotation of the second gear set during the dwell of the piston.

In at least one embodiment, an angular extent of the smooth surface portion of the first gear from the given gear pair and a rotation of the first gear are selected to control a dwell time of the piston.

In at least one embodiment, either gear set includes at least one groove, at least one slot, at least one rod, or at least one pin that is located on a gear to facilitate intermittent rotational motion of the gears in the second gear set.

In at least one embodiment, a gear in either gear set includes at least one groove, at least one slot, at least one rod, or at least one pin to provide a surface to assist the teeth on a gear in the second gear set to reengage with the teeth on a paired gear from the first gear set and cause the gear in the second gear set to begin rotating after a period when the gear in the second gear set has been stationary.

In at least one embodiment, the drive mechanism comprises a plurality of first and second gear sets that are connected to a plurality of pistons for an engine with multiple pistons.

In at least one embodiment, the gears in the first and second gear sets that are configured to provide non-sinusoidal piston motion comprise spur gears, helical gears, worm gears, internal gears, screw gears, miter gears or bevel gears.

In at least one embodiment, one of the gear sets comprises at least two gears which each have a circumferential edge with one smooth portion and one toothed portion, and another of the gear sets comprises at least one gear having a continuous toothed portion along the entire circumferential edge and a single gear having a smooth concave portion surrounded by a continuous toothed portion.

In at least one embodiment, the at least two gears with one smooth portion and one toothed portion are arranged relative to one another so that the toothed portions of the at least two gears are angularly offset from one another so as not to overlap.

In at least one embodiment, each of the first and second set of gears has a single gear, and a gear from one of the gear sets has a circumferential edge with two smooth portions and two toothed portions that alternate in angular position and a gear from the other gear set has two toothed portions along a majority of the circumferential edge and separated from one another by two smooth concave portions.

In another aspect, in accordance with the teachings herein there is provided an engine drive mechanism comprising: a first gear set including a first number of gears that are arranged to rotate in unison about a first axis; a second gear set including a second number of gears, the second number of gears being arranged to rotate about a second axis and have diameters selected to engage one of the gears from the first gear set during a portion of a rotational cycle of the gear sets where gears from the gears sets that engage one another form a gear pair having a gear ratio based on the diameters of those gears; and a piston connected to the second gear set, the piston being configured to travel different distances when each gear pair engage one another based on the angular extent that a gear from the first gear set engages a corresponding gear from the second gear set, a rotational speed of the gear from the first gear set and the gear ratio for the gear pair.

In at least one embodiment, one of the gear pairs has a first gear with a circumferential edge with a smooth portion that is configured to engage a smooth concave portion on a circumferential edge of the second gear to cause the second gear set to stop rotating thereby providing a dwell for the piston.

Other features and advantages of the present application will be apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIGS. 1 to 3 show a front view (with non-visible layers shown with dashed lines), a top view, and a front perspective view, respectively, of an example embodiment of a piston drive mechanism capable of generating four rotational speeds of a gear set (including stopping) and corresponding non-sinusoidal linear piston motion for one connected piston, in accordance with the teachings herein.

FIGS. 4A to 4D show front views (with non-visible layers shown with dashed lines) of the example embodiment of the piston drive mechanism for a single piston of FIGS. 1 to 3 at four positions in an engine cycle, demonstrating each of the four rotational speeds and thus showing a piston that can dwell and move three different distances during a portion of each full rotation of the engine cycle in accordance with the teachings herein.

FIGS. 5A and 5B show front views of another example embodiment of a piston drive mechanism for a single piston at two positions in an engine cycle, demonstrating a piston that has two dwells during one rotation of the engine cycle in accordance with the teachings herein.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices or methods having all of the features of any one of the devices or methods described below or to features common to multiple or all of the devices and or methods described herein. It is possible that there may be a device or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical connotation. For example, as used herein, the terms coupled or coupling may mean that two elements can be directly connected to one another or connected to one another through at least one intermediate mechanical element or device, depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “similarly”, “about” and “approximately” as used herein mean a reasonable amount of deviation of the modified term such that the end result is not significantly changed. These terms of degree may also be construed as including a deviation of the modified term, such as 1%, 2%, 5%, or 10%, for example, if this deviation does not negate the meaning of the term it modifies.

Furthermore, the recitation of numerical ranges by endpoints herein includes all numbers and fractions subsumed within that range (e.g. 1 to 5 includes any number between 1 to 5 such as, but not limited to, 1, 1.5, 2, 2.75, 3, 3.90, 4, and 5, for example). It is also to be understood that all numbers and fractions thereof are presumed to be modified by the term “about” which means a variation of up to a certain amount of the number to which reference is being made if the end result is not significantly changed, such as up to 1%, 2%, 5% or 10%, for example.

The majority of engines operate with their pistons connected to a crankshaft that rotates in a circular motion, which results in pistons that follow a sinusoidal motion. This provides a simple way to convert between the linear motion of the pistons and the continuous rotation of the crankshaft. However, when pistons are constrained to sinusoidal motion, the engines are prevented from following their optimal thermodynamic cycles. This is especially true for the external heat engine cycles known as Stirling and Ericsson cycles, since ideally they require the pistons to remain stationary, or dwell, during a portion of the cycle. The inventors have realized that deviating from conventional cranking mechanisms can allow for a continuously rotating output shaft and non-sinusoidal piston motion, with the ability to travel different distances during a portion of each cycle and dwell, which leads to engines capable of more closely following the ideal thermodynamic cycles that yield improved power and efficiency.

In accordance with the teachings herein, to better follow an ideal thermodynamic cycle, piston motion in engines may be controlled mechanically by gears or gear-like devices. Since the gears can be designed to have different diameters, different numbers of teeth, and have some teeth removed and replaced with circumferential smooth portions, the rotation of a set of gears can be strictly controlled while another set may continuously rotate. Gears are defined herein to include rotating wheels, with or without teeth, which also includes rotating wheels that have a toothed portion and a circumferential smooth portion having a preselected circumferential length. The gears can be used to provide or receive a non-sinusoidal driving force to or from another element, such as a shaft or a piston. By mounting a piston to a controllable gear system, the piston motion can be controlled and made to be non-sinusoidal, resulting in dwell times and different specific distances travelled by the piston during each portion of the cycle; these different distances and dwell times can be selected to more closely follow an ideal thermodynamic cycle. The continuously rotating gear(s) may be coupled to, or disposed on, the power output shaft of an engine. Accordingly, the gears described herein can be implemented such that the pistons can be made to follow non-sinusoidal motion to follow the ideal thermodynamic cycles, while the power output shaft continuously rotates, which is required for applications that use this output, such as a generator or a pump. The result is an increase in power output and efficiency for the engine.

It should be understood that while pistons are generally described in this application, the term piston is also meant to cover situations in which a displacer is used to move working fluid in a cylinder. Accordingly, the term piston should also be considered to cover displacers in this description and in the claims.

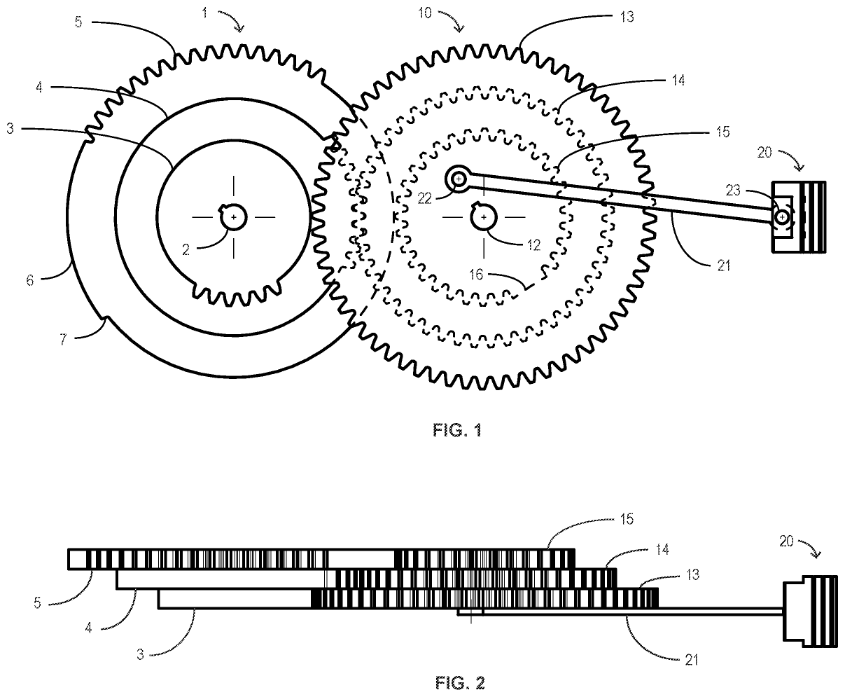

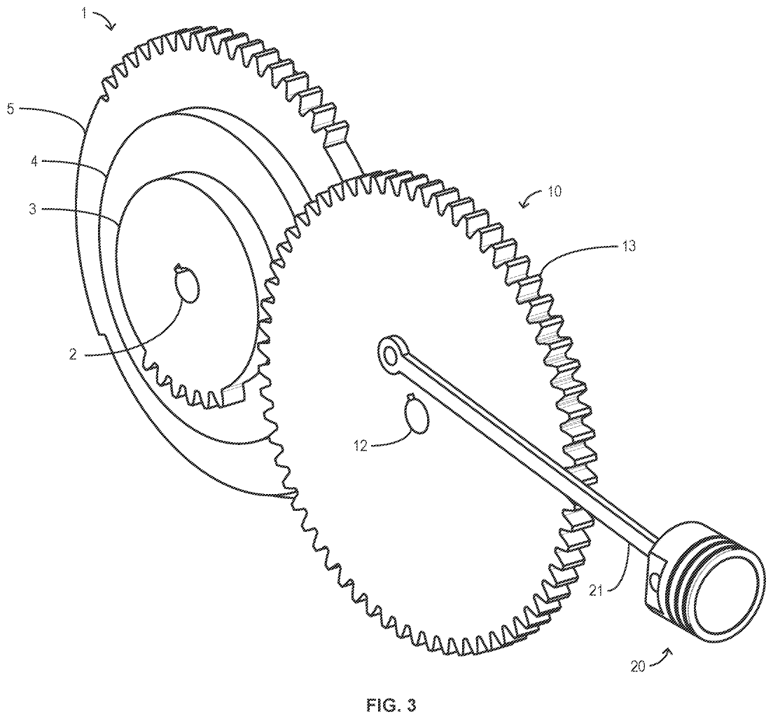

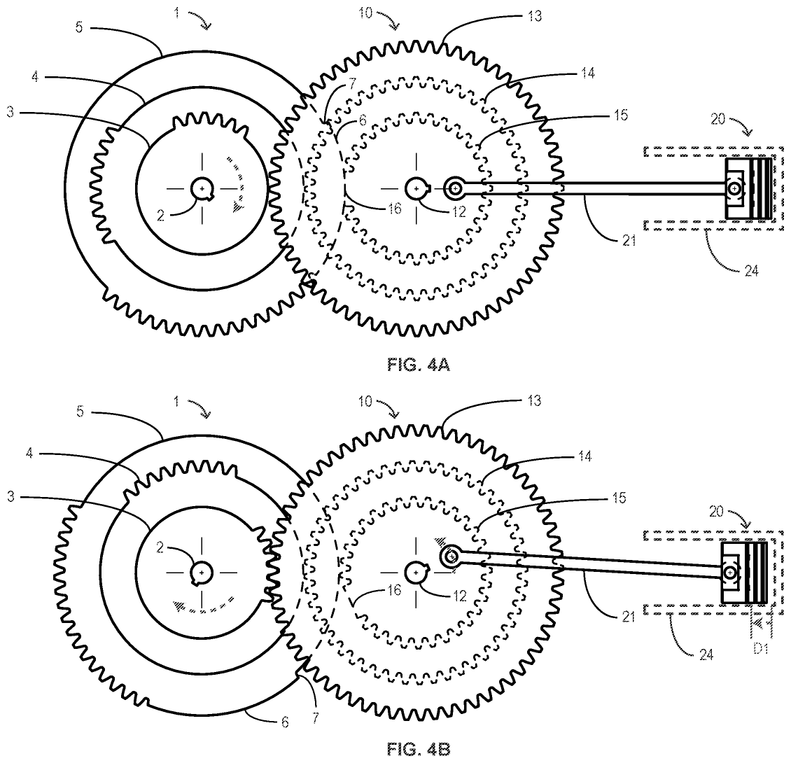

Referring now to FIGS. 1 to 3, illustrated therein is an example embodiment of a drive mechanism comprising a continuously rotating set of gears 1, a controllable set of gears 10, and a piston 20 connected to gear set 10. The gear sets 1 and 10 are configured to produce varying rotational speed, including no rotation, of gear set 10, while gear set 1 rotates continuously. Correspondingly, the piston 20 connected to gear set 10 can dwell and move specific controllable distances during a portion of the rotation of gear set 1, which results in an increase of the efficiency of an engine that uses the drive mechanism. The associated terminology and the mechanical arrangement provided herein are done so for ease of illustration and are not intended as a full scale kinematic solution.

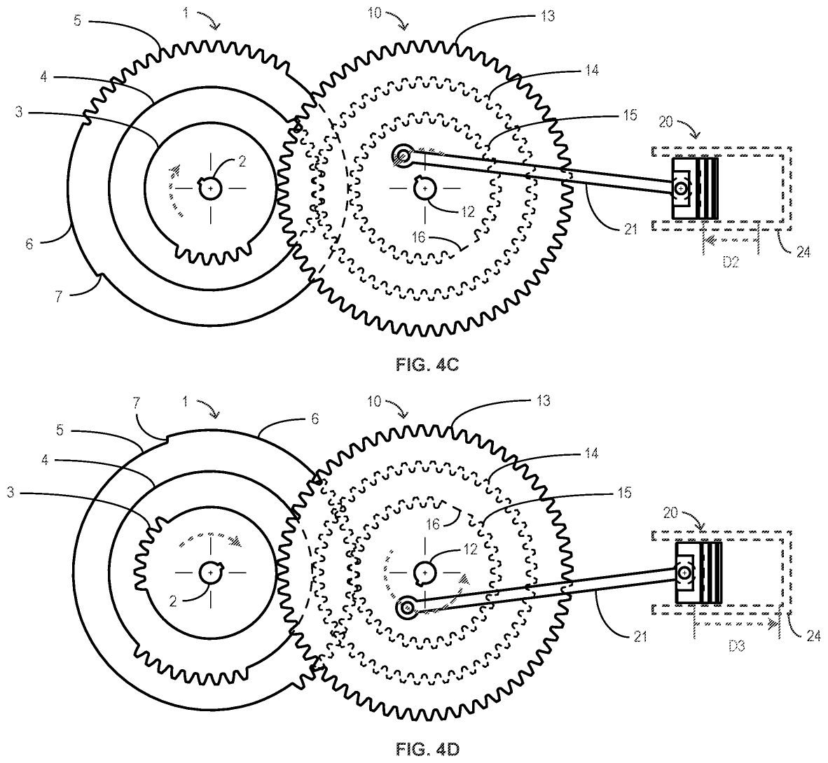

The gear set 1 comprises three gears 3, 4, and 5 affixed to each other to rotate together, and an opening 2 to mount the gear set 1 to a shaft (not shown). The gears 3, 4 and 5 can be affixed to each other in a standard manner, including but not limited to welding, adhesives, bolting, or other methods so long as they rotate together. In this example, a first keyed shaft can be mounted at the opening 2 to connect gear set 1 to a power output shaft, but in other embodiments other standard mountings can be used, including standard shaft mountings such as a press fit, set screw, and others. A power output shaft located and coupled at opening 2 will also be attached or coupled to the intended application apparatus, which includes but is not limited to, an electrical generator, an irrigation pump, or used directly for powering a vehicle, for example. Although three gears are shown in this embodiment, in other embodiments the number of gears can be one, two, four or more to generate non-sinusoidal motion of the piston 20. The three gears 3, 4, and 5 interact with gears 13, 14, and 15, respectively, on gear set 10. Generally, the number of gears in each gear set is selected according to how many different rotational speeds and dwells are required, which is based on the thermodynamic cycle that is being followed and the corresponding desired piston motion. The size ratios for the gears that couple with one another from the two gear sets 1 and 10 are selected according to the desired travel distance of the connected piston 20 for a certain portion of the thermodynamic cycle. For example, when the teeth of gear 5 engage the teeth of gear 15 the rotational speed of gear 15 is faster than the rotational speed of gear 5 by a multiple that is the diameter of the pitch circle of gear 5 divided by the diameter of the pitch circle of gear 15, according to standard gearing principles. The specific piston motion generated from the embodiment shown is described in detail in FIGS. 4A-4D.

The gear set 10 comprises the three gears 13, 14, and 15 affixed to each other or affixed to a common axle or shaft so as to rotate together, and an opening 12 to mount the gear set 10 to an axle (in general) although in some cases this axle may be a shaft (not shown). The gears 13, 14 and 15 can be affixed to each other in a standard manner, including but not limited to welding, adhesives, bolting, attachment to a common axle or shaft, or other methods so long as they rotate together. In this example, a second keyed axle or shaft can be mounted at the opening 12, but any mounting can be used so long as it keeps the gear set 10 in place and allows rotation.

In this example, a connecting rod 21 is connected directly to gear set 10 with a pin and bearing at 22 to directly convert between the rotational motion of the gear set 10 and the linear motion of the piston 20. The piston 20 is constrained to linear motion by the piston cylinder (see cylinder 24 in FIG. 4A for example), so the conversion between linear piston motion and rotational gear motion is enabled by the free rotation of the bearing at 22 and another bearing at 23. However, in alternative embodiments, the piston 20 may be coupled in other ways to gear set 10, including but not limited to the use of multiple linkages and rocker arms.

In general, the number of times N that a toothed portion from a gear in one of the gear sets (i.e. gear set 1 in this example) engage with the teeth from a gear in the other of the gear sets (i.e. gear set 10 in this example) during a single rotation of gear set 10 is equal to the number of times the piston 20 moves during a full cycle of the piston, where N is an integer. Also the number of times M that a smooth surface from a gear in one of the gear sets (i.e. gear set 1 in this example) slidably contacts a smooth concave surface from a gear in the other of the gear sets (i.e. gear set 10 in this example) during a single rotation of gear set 10 is equal to the number of dwells during a full cycle of the piston, where M is an integer. The number of times that a piston moves, the distance travelled during each piston movement, and the number of dwells used in an engine cycle can be selected to improve power and/or efficiency depending on the thermodynamic cycle and the configuration of the pistons/displacers relative to one another.

Referring now to FIGS. 4A to 4D, shown therein are schematic front views of gear sets 1 and 10, where gear set 10 is coupled to the piston 20 with the connecting rod 21. The piston 20 moves within a cylinder 24, which is shown as a cross-section. In this example, these four figures show how the piston 20 can be made to dwell and travel three different distances during a specific portion of the cycle (90 degrees of rotation from gear set 1) while gear set 1 continuously rotates with a constant rotational velocity.

In FIG. 4A, gear set 1 is shown as rotating clockwise while gear set 10 remains stationary, where the dashed arrow on gear 3 shows the direction and distance of travel. Correspondingly, the piston 20 is also stationary thus generating a dwell, which is required for many ideal thermodynamic cycles, such as the Stirling cycle. Gear set 10 remains stationary because the smooth concave surface 16 on gear 15 is in slideable contact with the smooth surface 6 of gear 5. The smooth surface 6 of gear 5 slides along surface 16 of gear 15 as gear set 1 rotates, which prevents gear set 10 from rotating. There may be cases where a force/torque is applied to the gears from the piston 20 or another source, so during a dwell the gear set 10 is held in place and prevented from rotating by using the smooth concave surface 16, since when the smooth concave surface 16 is in contact with a smooth portion of gear 6 then gear 15 does not rotate. The smooth concave surface 16 and corresponding surface 6 may be on one or more of the gear pairs (i.e. 3 paired with 13, 4 paired with 14, and/or 5 paired with 15) in the gear sets, and which ones are selected may be based on several factors including but not limited to which gear pair yields the lower amount of friction and/or the smoothest transition between the movement of the piston 20 and the dwell of the piston 20. Once gear set 1 rotates to the point where the smooth surface 6 on gear 5 has a reduction in radius at shoulder 7 (e.g. stepdown 7), the smooth surface 16 on gear 15 will no longer be in contact with a surface portion of gear 5 that prevents rotation; therefore, gear 15, and thus gear set 10, will be free to rotate and the gear teeth on gear 15 will have clearance to rotate due to the reduced radius of gear 5 at shoulder 7. The shoulder 7 can be used on any gear from the first gear set that is used to prevent rotation of a paired gear (i.e. a corresponding gear from the second gear set) when a dwell occurs. This is an example of how the gears can be used to generate a piston dwell (in which the piston does not move) during an engine cycle.

In FIG. 4B, gear set 1 is shown as rotating clockwise approximately 90 degrees from the position shown in FIG. 4A, and gear set 10 is rotating counterclockwise, where the dashed arrows show the direction and distance of travel. Correspondingly, the piston 20 is moving to the left through the engine cylinder 24, a distance of D1. The teeth on gear 3 have come into contact with the teeth on gear 13, thus causing gear set 10 to rotate counterclockwise, with a rotational speed that is slower than the rotational speed of gear set 1 due to the larger diameter of gear 13 relative to the diameter of gear 3. This results in the piston 20 travelling the relatively short distance D1 during the 90 degrees of rotation of gear set 1. This distance of travel D1 can be controlled by altering the size ratio (i.e. ratio of the pitch circle diameters) between gears 3 and 13. It is important to have control over this distance of travel since it correlates to control over the swept volume in the engine cylinder, which is an important variable to manipulate to ensure that the engine follows a desired thermodynamic cycle and operates at optimal power and efficiency.

In FIG. 4C, gear set 1 is shown as rotating clockwise approximately 90 degrees from the position shown in FIG. 4B, and gear set 10 is rotating counterclockwise, where the dashed arrows show the direction and distance of travel. Correspondingly, the piston 20 is moving to the left through the engine cylinder 24, a distance of D2. The teeth on gear 4 have come into contact with the teeth on gear 14, thus causing gear set 10 to rotate counterclockwise with a rotational speed that is the same as the rotational speed of gear set 1 (and faster than the rotational speed in FIG. 4B), since the pitch circle diameter of gear 14 is the same as the pitch circle diameter of gear 4. This results in the piston 20 travelling a relatively longer distance compared to the distance travelled in FIG. 4B (i.e. D2 is larger than D1) during another 90 degrees of rotation of gear set 1 and thus having a larger swept volume. Similar to the example shown in FIG. 4B, the size ratio (i.e. ratio of the pitch circle diameters) between gears 4 and 14 can be altered to set the distance D2 that piston 20 travels.

In FIG. 4D, gear set 1 is shown as rotating clockwise approximately 90 degrees from the position shown in FIG. 4C, and gear set 10 is rotating counterclockwise, where the dashed arrows show the direction and distance of travel. Correspondingly, the piston 20 is moving to the right through the engine cylinder 24, a distance of D3. The teeth on gear 5 have come into contact with the teeth on gear 15, thus causing gear set 10 to rotate counterclockwise with a rotational speed that is faster than the rotational speed of gear set 1 (and faster than the rotational speed in FIGS. 4B and 4C), since the pitch circle diameter of gear 15 is smaller than the pitch circle diameter of gear 5. This results in the piston 20 travelling a relatively longer distance compared to the distances shown in FIGS. 4B and 4C (i.e. D3 is larger than D2 and D1) during a further 90 degree of rotation of gear set 1 and thus having a larger swept volume. Similar to the examples shown in FIGS. 4B and 4C, the size ratio (i.e. ratio of the pitch circle diameters) between gears 5 and 15 can be altered to set the distance D3 that piston 20 travels.

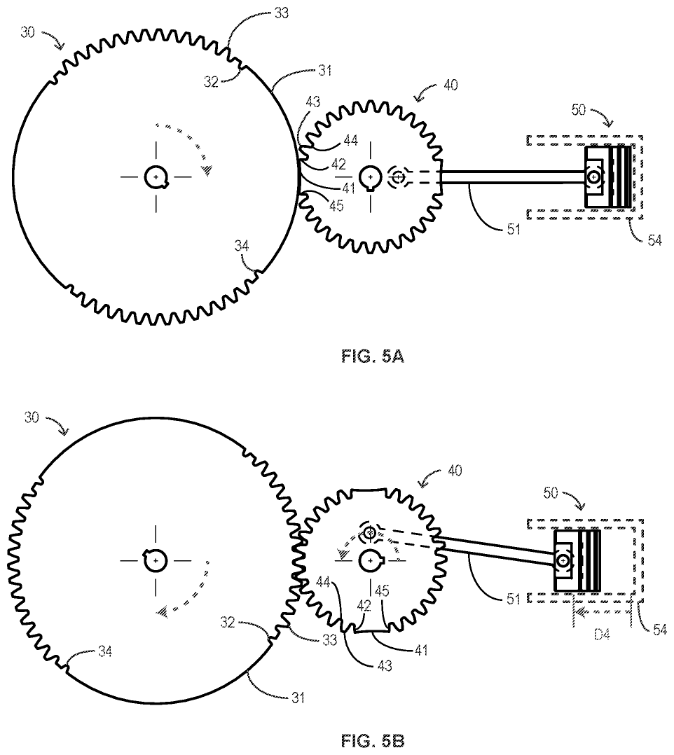

Referring now to FIGS. 5A and 5B, shown therein are schematic front views of an alternative embodiment of a drive mechanism comprising gears 30 and 40, where gear 40 is coupled to a piston 50 with a connecting rod 51. The piston 50 moves within a cylinder 54, which is shown as a cross-section. In this embodiment there is only one gear on each gear set and the piston can dwell and travel one set distance D4 during a portion of the cycle.

In FIG. 5A, gear 30 is shown as rotating clockwise while gear 40 remains stationary, where the dashed arrow shows the direction and distance of travel. Gear 40 has a smooth surface 41, which is concave, and is in slideable contact with the smooth surface 31 of gear 30 thus preventing rotation of gear 40 while gear 30 continues to rotate. Surface 31 slides along surface 41 as gear 30 rotates, which prevents gear 40 from rotating. Correspondingly, the piston 50 is also stationary, thus generating a dwell. This is an example of how the gears can be used to generate a piston dwell during the cycle for 90 degrees of rotation of gear 30, which in this case corresponds to one quarter of the full cycle of piston motion. In general, the sizes of the smooth surface 31 and the other smooth surface on gear 30 can be chosen to correspond with the portion of the rotation of gear 30 when the piston 50 is required to dwell. If the piston is required to dwell for X degrees of the rotation of gear 30, then the portion of the gear in the first gear set that has a smooth surface is (X/360)*circumference of the gear. In general, the number of times that a smooth concave surface on a gear in the gear set that is attached to the piston 50 (in this case gear 40) slidably contacts a corresponding smooth surface on their paired gear in the other gear set (in this case gear 30) during a full rotation of the gear that is attached to the piston 50 (in this case gear 40) is equal to the number of dwells of the piston 50 during one full cycle of the piston motion, and in the case shown here there are 2 dwells.

In FIG. 5B, gear 30 is shown as rotating clockwise approximately 90 degrees from the position shown in FIG. 5A, and gear 40 is rotating counterclockwise, where the dashed arrows show the direction and distance of travel. Correspondingly, the piston 50 is moving to the left through the engine cylinder 54, a distance of D4. The tooth 33 on gear 30 has come into contact with the tooth 43 on gear 40, thus engaging the teeth on gear 40 and causing gear 40 to rotate counterclockwise with a rotational speed that is faster than the rotational speed of gear 30. In this example, this results in the piston 50 travelling the full distance D4 through the engine cylinder (also known as top dead center to bottom dead center) during 90 degrees of rotation of gear 30 (i.e. one quarter of the engine cycle). In this example, as gear 30 continues to rotate (not shown), this pattern repeats and there is another 90 degrees of dwell for piston 50 followed by the piston 50 moving to the right through the full distance of the engine cylinder 54 during the final 90 degrees of rotation of gear 30 to complete one full engine cycle. Similar to the examples shown in FIGS. 4B, 4C, and 4D, the size ratio (i.e. ratio of the pitch circle diameters) between gears 30 and 40 can be altered to set the relative speed and distance D4 that piston 50 travels. The number of teeth that engage between the gear pair of gear 30 and gear 40 and the radial location of where the connecting rod 51 is affixed to gear 40 can also be altered to set the relative speed and distance D4 that the piston 50 travels. The ability of a piston 50 to dwell during a portion of the cycle and travel the full distance through the engine cylinder 54 is important to enable an engine to follow ideal thermodynamic cycles, such as the Stirling cycle.

In the embodiment shown in FIGS. 5A and 5B there is a notch 32 to facilitate the engagement of the teeth on gear 30 with the teeth on gear 40. The notch 32 helps to give clearance for the edge 42 of surface 41 to rotate when tooth 33 on gear 30 engages with tooth 43 on gear 40, which causes gear 40 to begin to rotate. Tooth 33 can also be made radially longer to ensure it engages properly with tooth 43, and the gap at 44 can be made correspondingly radially deeper to give clearance for the longer tooth 33. The depth of the notch 32 and length of the tooth 33, and the corresponding depth of the gap at 44, will vary depending on the relative diameters of gears 30 and 40 and can be selected on a case by case basis. Similarly, the notch 34 helps to give clearance for the edge 45 of surface 41 to rotate when surface 41 slidably contacts surface 31. In other embodiments, other techniques may be used to facilitate the engagement of the teeth on gears 30 and 40 to facilitate gear 40 transitioning from being stationary to rotating, such as using pins and rods on the faces of the gears. Accordingly, at least one groove, at least one slot, at least one rod, or at least one pin can be used to facilitate the intermittent rotational motion of the gears in the second gear set. For example, a rod may be located on the top of gear 40 above surface 41 that sticks out above gear 30, such that a pin that protrudes upward from the surface of gear 30, near the notch 32 location, makes contact with the rod when the rotation of gear 30 brings them together, and this contact causes gear 40 to begin rotating after a period of dwell. Thus, at least one groove, at least one slot, at least one rod, or at least one pin provides a surface to assist the teeth on a gear in the second gear set to reengage with the teeth on a paired gear from the first gear set and cause the gear in the second gear set to begin rotating after a period when the gear in the second gear set has been stationary.

It should be understood that the dwell and motion patterns illustrated in FIGS. 4A to 5B are for demonstration purposes only and the drive mechanism may be altered to accommodate different thermodynamic cycles. In other embodiments an engine may have a number of pistons connected to a gear set, or a number of pistons each connected to different gear sets. For example, multiple pistons can be connected to a single gear set by attaching multiple connecting rods to a single pin, or to multiple pins on either side of a gear set, or connecting linkages and rocker arms to the gear set and connecting multiple pistons to these linkages.

Since the connecting rods 21 and 51 are responsible for transmitting force during conversion from linear to rotational motion, they may also experience a large compressive load from the expansion stroke, as well as tensile load from inertial effects of an engine or other system that they may be used with. Accordingly, the connecting rods 21 and 51 may be made from standard connecting rod materials, for example, forged steel, high strength aluminum or high strength titanium.

The gears 3-5, 13-15, 30, and 40 operate as traditional gears when toothed portions of gears 3 to 5 engage gears 13 to 15 and toothed portions of gear 30 engages gear 40 but they can also have slideable contact during dwells in which gears 13-15 and 40 do not rotate. The gears 3-5, 13-15, 30, and 40 may be made from standard gear materials such as steel or aluminum, and may have a surface coating that is able to withstand the teeth contact and rubbing during any dwells. The surface coating may be determined by experimental (e.g. longevity) testing on a case-by-case basis.

It should be understood that a gear from the first or second gear set can have only smooth surfaces where the purpose is to prevent rotation of the paired gear in the second gear set for a portion of the engine cycle. In this case there is at least one other gear in the first or second gear sets that engages the teeth on at least one paired gear so that the second gear set can rotate. This may be advantageous for the Stirling cycle since there are generally multiple pistons required and the cold and hot pistons may each be connected to separate first gear sets that are coupled to a power output shaft for continual rotation. Thus, while the hot piston might be moving (i.e. for expansion), the cold piston can be prevented from moving to more closely follow the ideal Stirling cycle. In some cases, a flywheel on the output shaft may also be used to help rotate the output shaft and first gear sets (i.e. drive gear sets) during these portions of the cycle.

It should be understood that the example embodiments of the engine assemblies shown in FIGS. 1-5B will include additional components as is known to those skilled in the art that are needed for the proper operation of an engine such as, but not limited to, bearings for pivot points (e.g. needle rollers, sealed and non-sealed ball bearings, and/or sliding bearings), gaskets for mating structural metallic components, as well as tubing, fins and plates for heat acceptor and expulsion components, for example. Various materials, such as, but not limited to, steel, stainless steel, aluminum, copper, and titanium, for example, as well as surface treatments may be used for the dynamic and static components as needed. Other components that may be used with the engine assembly include, but are not limited to, piston assemblies (e.g. pistons, piston rings, cylinders, mounting pins), connecting rods, flywheels, starter mechanisms, power output shafts, cooling units, and heat input/burner units, for example. These additional components are not shown for ease of illustration and to focus on the structural and operational characteristics of the drive mechanism.

The burner unit for an engine that incorporates at least one of the gear arrangements described herein may burn a wide range of inputs including, but not limited to, wood and biomass, and also fuels such as butane and propane, for example. Such an engine may also include a connection port for a solar thermal concentrator input. Accordingly, to power the engine, the user can select from a wide range of fuels or heat inputs based on what is available.

Applications for the engines described herein are vast and include, but are not limited to, producing electrical power by connecting to a generator, powering pumps (e.g. for wells, agriculture, or small business needs), and operating small machinery (e.g. threshers and other small farm equipment), for example. Alternative embodiments of engine models may also include multiple pistons so the engine can be scaled up in multiples of a certain power output per unit. Users can then select from a range of engines with a power output specific to each application.

It should be noted that while the examples show that the number of gears in the first gear set is the same as the number of gears in the second gear set, there may be embodiments in which this is not the case. For example one of the gear sets may include an extra gear. For example, a gear for one gear set may have a thickness 2T and it may engage two gears on a second gear set which are adjacent to one another and each have a thickness of T.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An engine drive mechanism comprising:
a first gear set including a first number of gears affixed to each other or attached to a common shaft to rotate together, the first gear set being coupled to a continuously rotating output shaft, each gear in the first gear set having a circumferential surface with at least one smooth portion and/or at least one toothed portion;
a second gear set including a second number of gears, the second gear set being disposed about an axis of rotation, each gear in the second gear set having a circumferential surface with at least one smooth portion and/or at least one toothed portion and being arranged to abut against a corresponding gear from the first gear set to form a gear pair having a gear ratio; and
a piston connected to the second gear set, the piston being configured to travel various distances during certain portions of each engine cycle when teeth on each gear in a given gear pair engage one another, and/or the piston is configured to dwell when smooth surface portions on each gear in the given gear pair are in slidable contact with one another.

2. The drive mechanism of claim 1, wherein the piston has a force exerted on it by the second gear set and the piston exerts a force on the second gear set to transfer load and generate output shaft work.

3. The drive mechanism of claim 1, wherein a number N of times that a toothed portion from a gear in one of the gear sets engages with the teeth from a gear in another of the gear sets during a single rotation of the second gear set is equal to a number of times the piston moves during a full cycle of the piston, where N is an integer.

4. The drive mechanism of claim 1, wherein a ratio of pitch circle diameters for gears in a gear pair is selected to define a distance that the piston travels when toothed portions of the gears in the gear pair engage one another.

5. The drive mechanism of claim 1, wherein a number M of times that a smooth surface from a gear in one of the gear sets slidably contacts a smooth concave surface from a gear in another of the gear sets during a single rotation of the second gear set is equal to a number of dwells during a full cycle of the piston, where M is an integer.

6. The drive mechanism of claim 1, wherein a smooth surface portion of a first gear from the given gear pair has a shape for slideable contact with a smooth concave surface portion of a second gear from the given gear pair to prevent rotation of the second gear set during the dwell of the piston.

7. The drive mechanism of claim 6, wherein an angular extent of the smooth surface portion of the first gear from the given gear pair and a rotation of the first gear are selected to control a dwell time of the piston.

8. The drive mechanism of claim 1, wherein either gear set includes at least one groove, at least one slot, at least one rod, or at least one pin that is located on a gear to facilitate intermittent rotational motion of the gears in the second gear set.

9. The drive mechanism of claim 1, wherein a gear in either gear set includes at least one groove, at least one slot, at least one rod, or at least one pin to provide a surface to assist the teeth on a gear in the second gear set to reengage with the teeth on a paired gear from the first gear set and cause the gear in the second gear set to begin rotating after a period when the gear in the second gear set has been stationary.

10. The drive mechanism of claim 1, wherein the drive mechanism comprises a plurality of first and second gear sets that are connected to a plurality of pistons for an engine with multiple pistons.

11. The drive mechanism of claim 1, wherein the gears in the first and second gear sets that are configured to provide non-sinusoidal piston motion comprise spur gears, helical gears, worm gears, internal gears, screw gears, miter gears, or bevel gears.

12. The drive mechanism of claim 1, wherein one of the gear sets comprises at least two gears which each have a circumferential edge with one smooth portion and one toothed portion, and another of the gear sets comprises at least one gear having a continuous toothed portion along the entire circumferential edge and a single gear having a smooth concave portion surrounded by a continuous toothed portion.

13. The drive mechanism of claim 12, wherein the at least two gears with one smooth portion and one toothed portion are arranged relative to one another so that the toothed portions of the at least two gears are angularly offset from one another so as not to overlap.

14. The drive mechanism of claim 1, wherein each of the first and second set of gears has a single gear, and a gear from one of the gear sets has a circumferential edge with two smooth portions and two toothed portions that alternate in angular position and a gear from the other gear set has two toothed portions along a majority of the circumferential edge and separated from one another by two smooth concave portions.

15. An engine drive mechanism comprising:
a first gear set including a first number of gears that are arranged to rotate in unison about a first axis;
a second gear set including a second number of gears, the second number of gears being arranged to rotate about a second axis and have diameters selected to engage one of the gears from the first gear set during a portion of a rotational cycle of the gear sets where gears from the gears sets that engage one another form a gear pair having a gear ratio based on the diameters of those gears; and
a piston connected to the second gear set, the piston being configured to travel different distances when each gear pair engage one another based on the angular extent that a gear from the first gear set engages a corresponding gear from the second gear set, a rotational speed of the gear from the first gear set and the gear ratio for the gear pair.

16. The drive mechanism of claim 15, wherein one of the gear pairs has a first gear with a circumferential edge with a smooth portion that is configured to engage a smooth concave portion on a circumferential edge of the second gear to cause the second gear set to stop rotating thereby providing a dwell for the piston.
